(19) United States
(12) Patent Application Publication
(10) Pub. No.: US 2026/0204980 A1
(43) Pub. Date: Jul. 16, 2026

(54) Brushless Motor Structure

(71) Applicant: Huizhou Victory Technology Ltd, Huizhou City (CN)

(72) Inventor: Hesheng Liu, Huaihua City (CN)

(73) Assignee: Huizhou Victory Technology Ltd, Huizhou City (CN)

(21) Appl. No.: 19/090,781

(22) Filed: Mar. 26, 2025

(30) Foreign Application Priority Data
Jan. 14, 2025 (CN) 202510052460.7

(51) Int. Cl. H02K 7/12; H02K 21/22

(52) U.S. Cl. CPC H02K 7/12; H02K 21/22

(57) ABSTRACT

A brushless motor structure is provided, which includes a housing, a stator component, and a rotor component. The housing is matched with the stator component and the rotor component. The rotor component is provided on the housing, and the stator component is provided below the housing. The stator component is fixedly connected to the housing, and the rotor component is rotated relative to the housing through the stator component. The design of the present disclosure achieves a compact structure, longer service life, and simple maintenance by separating the stator component and rotor component and providing them separately inside and outside the housing. When the stator is damaged, only the stator needs to be replaced, without the need to replace the entire motor, effectively reducing maintenance costs.

### CROSS-REFERENCE TO RELATED APPLICATIONS

This application claims priority to Chinese Patent Application No. 202510052460.7, filed on January 14, 2025, which is hereby incorporated by reference in its entirety.

### TECHNICAL FIELD

The present disclosure relates to the field of motor technologies, and in particular, to a brushless motor structure.

### BACKGROUND

A motor is a device that converts electrical or other forms of energy into mechanical energy. The attraction generated by electromagnetic induction drives the rotor of the starter motor to rotate, while the small gear on the rotor also drives the flywheel of the engine to rotate. Specifically, when current flows through a conductor, a magnetic field is generated around the conductor. If a conductor (or coil) is placed in another magnetic field, according to the law of electromagnetic induction and Fleming's left-hand rule, the conductor will rotate under the action of force. Motors are widely used in industrial machinery, transportation vehicles, household appliances, and decorative crafts

Traditional brushless motors are supported by a shaft, and the motor housing rotates around the stator. Besides that, in some special industries, with a shaft, the rotation of any component of the housing, shaft, stator, or rotor can affect the effectiveness of use. For example, in the application of water drawing in the field of handicrafts, if the shaft is placed in the liquid to achieve agitation under the motion of the traditional motor mentioned above, water leakage may occur, thereby causing damage to the motor. Thus, it is necessary to develop an updated structural design that can effectively solve the above problems and has low maintenance costs.

### SUMMARY

The purpose of the present disclosure is to provide a brushless motor structure to solve problems of inability to meet specific usage scenarios, poor performance, and high production costs in the aforementioned background technology.

The present disclosure provides the following technical solution: a brushless motor structure a housing, a stator component, and a rotor component, where the housing is matched with the stator component and the rotor component, the rotor component is provided on the housing, the stator component is provided below the housing, the stator component and the housing are fixedly connected, and the rotor component is rotated relative to the housing through the stator component.

In some embodiments of the present disclosure, a cylindrical convex shell is provided on the housing, the cylindrical convex shell is fixedly connected or integrally formed with the housing, the rotor component is sleeved on the cylindrical convex shell, the stator component is provided below the cylindrical convex shell, the stator component is fixedly connected to the cylindrical convex shell and/or the housing, and the rotor component is rotated relative to the cylindrical convex shell through the stator component.

In some embodiments of the present disclosure, a rotor fixing member configured to prevent the rotor component from disengaging from rotation is provided on the rotor component and/or the housing, the rotor fixing member is fixedly connected or integrally formed with the housing and/or the cylindrical convex shell.

In some embodiments of the present disclosure, the rotor fixing member is a rotating shaft or a limiting element.

In some embodiments of the present disclosure, a limit block configured to prevent the rotor component from detaching during rotation is provided on the rotating shaft, the rotor component is matched and connected to the rotating shaft, and the rotor component is rotated relative to the rotating shaft through the stator component.

In some embodiments of the present disclosure, a shaft hole matching the rotating shaft is provided on the rotor component, and a width of the limit block is greater than a diameter of the shaft hole.

In some embodiments of the present disclosure, the limiting element is a "7"- shaped frame, a cross shaped frame, a M-shaped frame, a "il" character shaped frame, or a shell matched with the rotor component.

In some embodiments of the present disclosure, the rotor component includes a rotating magnet and a magnet shell that are matched with each other, the rotating magnet and the magnet shell are fixedly connected, the rotating magnet and the magnet shell are integrally sleeved on the cylindrical convex shell.

In some embodiments of the present disclosure, a power link is provided on the magnet shell, and the power link is fixedly connected or integrally formed with the magnet shell; the power link is rotated through a rotation of the rotating magnet and the magnet shell.

In some embodiments of the present disclosure, the power link is an impeller, a connection groove, or a connection buckle.

In some embodiments of the present disclosure, the rotating magnet is a magnetic ring or a magnetic sheet.

In some embodiments of the present disclosure, the stator component includes a stator and a control board, the stator and the control board are connected, and the control board is connected to an external power source.

In some embodiments of the present disclosure, a bottom of the housing is provided with a stator fixing part, and the stator component is fixedly connected to the housing or the cylindrical convex shell through the stator fixing part.

In some embodiments of the present disclosure, the stator fixing part is fixedly connected to the housing or the cylindrical convex shell in a sealing manner.

Compared with the existing technology, the beneficial effects of the present disclosure are as follows.

The brushless motor structure of the present disclosure includes a housing, a stator component, and a rotor component. The housing is matched with the stator component and the rotor component. The rotor component is provided on the housing, and the stator component is provided below the housing. The stator component is fixedly connected to the housing, and the rotor component is rotated relative to the housing through the stator component. By separating the stator component and rotor component and placing them inside and outside the housing, the structure is designed to be compact. When applied to specific scenarios, such as the field of water drawing in handicrafts, the stator component and rotor component are separated by the housing, so they will not be damaged due to water leakage; beside that, when the stator is damaged, only the stator needs to be replaced, without the need to replace the entire motor, thereby effectively reducing maintenance costs.

The brushless motor structure of the present disclosure has a cylindrical convex shell provided on the housing, which is fixedly connected or integrally formed with the housing. The rotor component is sleeved on the cylindrical convex shell, and the stator component is provided below the cylindrical convex shell. The stator component is fixedly connected to the cylindrical convex shell and/or the housing, and the rotor component is rotated relative to the cylindrical convex shell through the stator component. Through this structural design, the stator component and rotor component are separated and provided above and below the cylindrical convex shell. On the one hand, the rotor component is not easily detached, and on the other hand, the effect of the stator component driving the rotor component to rotate is more stable.

The brushless motor structure of the present disclosure is provided with a rotor fixing member on the rotor component and/or housing to prevent the rotor component from rotating. The rotor fixing member is fixedly connected or integrally formed with the housing and/or cylindrical convex shell. Through this design, it is possible to effectively prevent the rotor component from detaching, rendering the rotation effect of the rotor component more stable.

The brushless motor structure of the present disclosure has a rotor fixing member as a rotating shaft or a limiting element. When the rotor fixing member is the rotating shaft or a limiting block is provided on the shaft to prevent the rotor component from detaching during rotation. The rotor component is matched and connected to the shaft, and the rotor component is rotated relative to the shaft through the stator component. Through this design, the rotor component will not be detached during rotation and will not detached due to the buoyancy of the liquid when placed in liquid.

The brushless motor structure of the present disclosure is provided with a shaft hole on the rotor component that matches with the shaft, and the width of the limit block is greater than the diameter of the shaft hole. Through this structural design, the rotor component can rotate without detaching from the cylindrical convex shell.

The brushless motor structure of the present disclosure has a limiting element of a "7" - shaped frame, a cross shaped frame, a M-shaped frame, a "il" character shaped frame, or a shell matched with the rotor component. When the rotor fixing member is a limiting component, it can effectively prevent damage to the rotating magnet and limit the rotating magnet to prevent it from detaching during rotation.

The brushless motor structure of the present disclosure includes a rotor component including a rotating magnet and a magnet shell that are matched with each other. The rotating magnet and the magnet shell are fixedly connected, and the rotating magnet and the magnet shell are integrally fitted on the cylindrical convex shell. By providing the magnet shell, it is possible to effectively prevent damage to the rotating magnet and limit its movement, preventing it from detaching during rotation.

The brushless motor structure of the present disclosure is provided with a power link on the magnet shell, which is fixedly connected or integrally formed with the magnet shell. The power link is rotated by rotating the magnet and the magnet shell as a whole. By providing the power link, when the brushless motor structure is combined with other components, it can effectively provide power.

The brushless motor structure of the present disclosure has a rotating magnet that is a magnetic ring or a magnetic sheet. The rotating magnet can be effectively fitted onto the cylindrical convex shell, rendering its rotation more stable.

The brushless motor structure of the present disclosure has a stator fixing part at the bottom of the housing, and the stator component is fixedly connected to the housing or cylindrical convex shell through the stator fixing part. By providing the stator fixing part, it is possible to effectively prevent the stator components from falling off.

The brushless motor structure of the present disclosure is fixedly and connected to the stator fixing part and the housing or the cylindrical convex shell in a sealing manner. The stator fixing part is a sealed connection component, which is fixed and sealed with the housing or cylindrical convex shell, thereby rendering the stator components less prone to detachment while also having waterproof function.

### BRIEF DESCRIPTION OF DRAWINGS

In order to provide a clearer explanation of the embodiments or technical solutions in the present application or existing technology, a brief introduction will be given to the accompany drawing, it is obvious that the accompanying drawings described below are only some embodiments of the present application. For those skilled in the art, other drawings can be obtained based on these drawings without requiring creative work.

FIG. 1 is a semi-sectional schematic diagram of a brushless motor structure of the present disclosure.

FIG. 2 is a first exploded schematic diagram of the brushless motor structure of the present disclosure.

FIG. 3 is a second exploded schematic diagram of the brushless motor structure of the present disclosure.

FIG. 4 is a three-dimensional schematic diagram of a "7" - shaped limiting element of the brushless motor structure of the present disclosure.

FIG. 5 is a three-dimensional schematic diagram of a M-shaped limiting element of the brushless motor structure of the present disclosure.

FIG. 6 is a three-dimensional schematic diagram of a il" character shaped limiting element of the brushless motor structure of the present disclosure.

FIG. 7 is a three-dimensional schematic diagram of a limiting element of a housing matched with a rotor component of the brushless motor structure of the present disclosure.

Numeral reference: 1- housing; 11- cylindrical convex shell; 2- stator component; 21- stator; 22- control board; 3- rotor component; 31- rotating magnet; 32- magnet shell; 321- shaft hole; 33- power link; 4- rotor fixing member; 41- rotating shaft; 411- limit block; 42- limiting element; 5- stator fixing part.

### DESCRIPTION OF EMBODIMENTS

The following provides a detailed description of the embodiments of the present application, examples of which are shown in the accompanying drawings, where the same or similar reference numerals from beginning to end represent the same or similar elements or elements with the same or similar functions. The embodiments described below with reference to the accompanying drawings are exemplary and are only used to explain the present application, and should not be construed as limiting the present application.

In the description of this application, it should be understood that terms "first" and "second" are only used for descriptive purposes and cannot be understood as indicating or implying relative importance or implying the number of technical features indicated. Thus, the features limited to "first" and "second" may explicitly or implicitly include one or more of the aforementioned features. In the description of this application, the meaning of "multiple" refers to two or more, unless otherwise specifically limited.

In the description of this application, it should be noted that unless otherwise specified and limited, terms "installation" and "connection" should be broadly understood, for example, it can be a fixed connection, a detachable connection, or an integrated connection; it can be a mechanical connection, an electrical connection, or communication with each other; it can be directly connected or indirectly connected through an intermediate medium, and it can be a connection within two components or an interaction relationship between two components. For those skilled in the art, specific meanings of the above terms in this application can be understood according to a specific situation.

In the description of this application, it should be understood that terms "up", "down", "side", "front", "back", etc. indicate orientation or position relationships based on installation, only for the convenience of describing this application and simplifying the description, and do not indicate or imply that the device or component referred to must have a specific orientation, be constructed and operated in a specific orientation, and therefore cannot be understood as a limitation of this application.

In the description of this application, it should be noted that term "and/or" is only a description of the association relationship between related objects, indicating that there can be three types of relationships, such as A and/or B, which can represent: the existence of A alone, the existence of A and B at the same time, and the existence of B alone.

It should be noted that in the embodiments of the present application, the same reference numerals are used to represent the same components or parts. For the same parts in the embodiments of the present application, only one part or component may be marked with a reference numeral in the figure. It should be understood that for other identical parts or components, the reference numerals are also applicable.

Besides that, in this application, the technical features described in an open manner include both closed technical solutions composed of the listed features and open technical solutions containing the listed features.

In order to further understand the disclosure content, characteristics, and efficacy of the present application, the following embodiments are listed and explained in detail with the accompanying drawings:

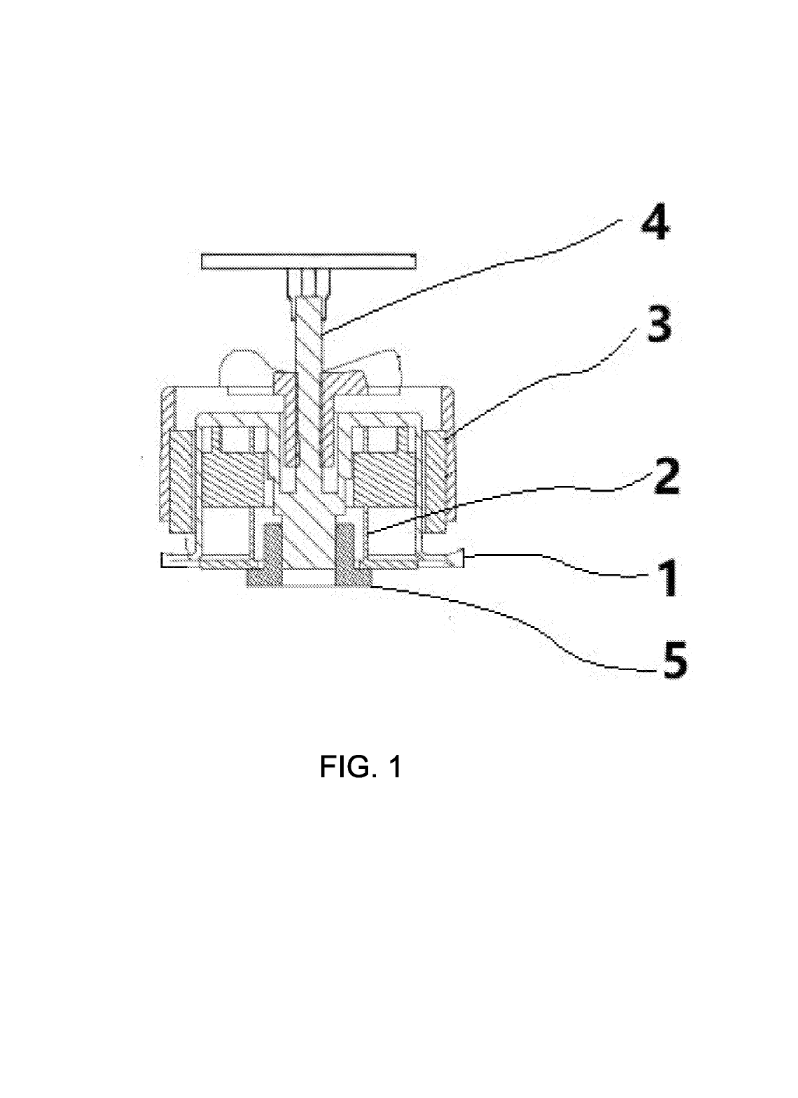

As shown in FIGS. 1-3, a brushless motor structure includes a housing 1, a stator component 2, and a rotor component 3. The housing 1 is matched with the stator component 2 and the rotor component 3, and the rotor component 3 is provided on the housing 1. The stator component 2 is provided below the housing 1 and fixedly connected to the housing 1, and the rotor component 3 is rotated relative to the housing 1 through the stator component 2. In this embodiment, the structure is designed to be compact by separating the stator component and rotor component and placing them separately inside and outside the housing. When applied in the field of handicraft water drawing, the stator component and rotor component are separated by the housing, so they will not be damaged due to water leakage. Besides that, when the stator is damaged, only the stator needs to be replaced, without the need to replace the entire motor, thereby effectively reducing maintenance costs. Of course, the above structural design is not limited to this and can be other structures that serve the same purpose.

In an implementation mode, the housing 1 is provided with a cylindrical convex shell 11, which is fixedly connected or integrally formed with the housing 1. The rotor component 3 is sleeved on the cylindrical convex shell 11, and the stator component 2 is provided below the cylindrical convex shell 11. The stator component 2 is fixedly connected to the cylindrical convex shell 11 and/or the housing 1. The rotor component 3 is rotated relative to the cylindrical convex shell 11 through the stator component 2. In this embodiment, through this structural design, the stator component and rotor component are separated and placed above and below the cylindrical convex shell. On the one hand, the rotor component is not easily detached, and on the other hand, the effect of the stator component driving the rotor component to rotate is more stable. Of course, the above structural design is not limited to this and can be other structures that serve the same purpose.

In an implementation mode, a rotor fixing member 4 is provided on the rotor component 3 and/or the housing 1 to prevent the rotor component 3 from disengaging and rotating. The rotor fixing member is fixedly connected or integrally formed with the housing 1 and/or the cylindrical convex shell 11. In this embodiment, the rotor fixing member is fixedly connected to the housing and/or the cylindrical convex shell, and through the rotor fixing member, it effectively prevents the rotor component from detaching from the cylindrical convex shell, rendering its rotation effect more stable. Of course, the above structural design is not limited to this and can be other structures that serve the same purpose.

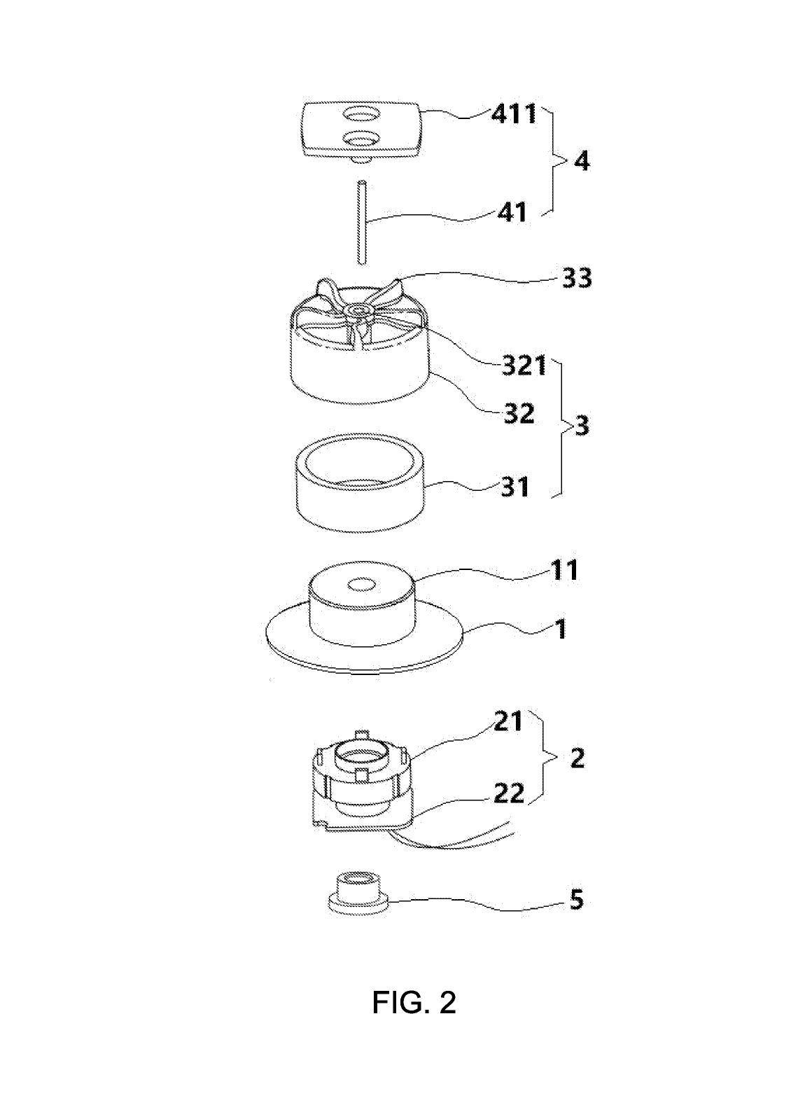

In an implementation mode, as shown in FIG. 2, the rotor fixing member 4 is a rotating shaft 41 or a limiting element 42. A limit block 411 is provided on the rotating shaft 41 to prevent the rotor component 3 from disengaging during rotation. The rotor component 3 is matched and connected to the rotating shaft 41, and the rotor component 3 is rotated relative to the rotating shaft 41 through the stator component 2. In this embodiment, the rotor fixing member is the rotating shaft, and by providing the limit block on the rotating shaft, the rotor component can be prevented from detaching from the cylindrical convex shell. Of course, the above structural design is not limited to this and can be other structures that serve the same purpose.

In an implementation mode, a shaft hole 321 is provided on the rotor component 3 that matches with the rotating shaft 41, and a width of the limit block 411 is greater than a diameter of the shaft hole 321. In this embodiment, as shown in FIG. 2, the width of the limit block is greater than the diameter of the shaft hole. Through this structural design, the rotor component can rotate without detaching from the cylindrical convex shell. Of course, the above structural design is not limited to this and can be other structures that serve the same purpose.

In an implementation mode, the rotor component 3 includes a rotating magnet 31 and a magnet shell 32 that are matched with each other. The rotating magnet 31 and the magnet shell 32 are fixedly connected, and the rotating magnet 31 and the magnet shell 32 are integrally provided on the cylindrical convex shell 11. In this embodiment, by providing the magnet shell, it is possible to effectively prevent damage to the rotating magnet and limit it to prevent it from detaching during rotation. Of course, the above structural design is not limited to this and can be other structures that serve the same purpose.

In an implementation mode, a power link 33 is provided on the magnet shell 32, which is fixedly connected or integrally formed with the magnet shell 32. The power link 33 is rotated by rotating the magnet 31 and the magnet shell 32 as a whole. In this embodiment, by providing the power link, the brushless motor structure can provide power to other components when combined. Of course, the above structural design is not limited to this and can be other structures that serve the same purpose.

In an implementation mode, the power link 33 is an impeller, a connection groove, or connection buckle. In this embodiment, the power link is the connection groove, which is a sliding connection. Through this structural design, when the brushless motor structure is combined with the water drawing handcraft, the connection groove and the stirring structure are connected to provide power for its water drawing. Of course, the power link is not limited to this and can also be other shapes or structures that serve the same purpose.

In an implementation mode, the rotating magnet 31 is a magnetic ring or a magnetic sheet. In this embodiment, the rotating magnet is the magnetic ring, which makes its rotation effect on the cylindrical convex shell more stable through this design. Of course, the rotating magnet is not limited to this and can also be other structures or shapes that serve the same purpose.

In an implementation mode, the stator component 2 includes a stator 21 and a control board 22, the stator 21 and the control board 22 are connected, and the control board 22 is connected to an external power source. In this embodiment, the control board can generate a magnetic field by energizing the stator components after being connected to the external power source. Of course, the above structural design is not limited to this and can be other structural designs that serve the same purpose.

In an implementation mode, a bottom of the housing 1 is provided with a stator fixing part 5, and the stator component 2 is fixedly connected to the housing 1 through the stator fixing part 5. In this embodiment, the motor fixing component is a T-shaped plug, which fixes the stator component in the housing through the stator fixing part, rendering the stator component less likely to fall off. Of course, the shape of the stator fixing part is not limited to this, and can be other structures or shapes that serve the same purpose.

In an implementation mode, the stator fixing part 5 is fixedly connected to the housing 1 or the cylindrical convex shell 11 in a sealing manner. In this embodiment, the stator fixing part is a sealed fixing component, which is connected to the cylindrical convex shell for sealing and fixing, so that the stator component is not easily detached and having waterproof function. Of course, the type of stator fixing part is not limited to this and can be other fixing parts that serve the same purpose.

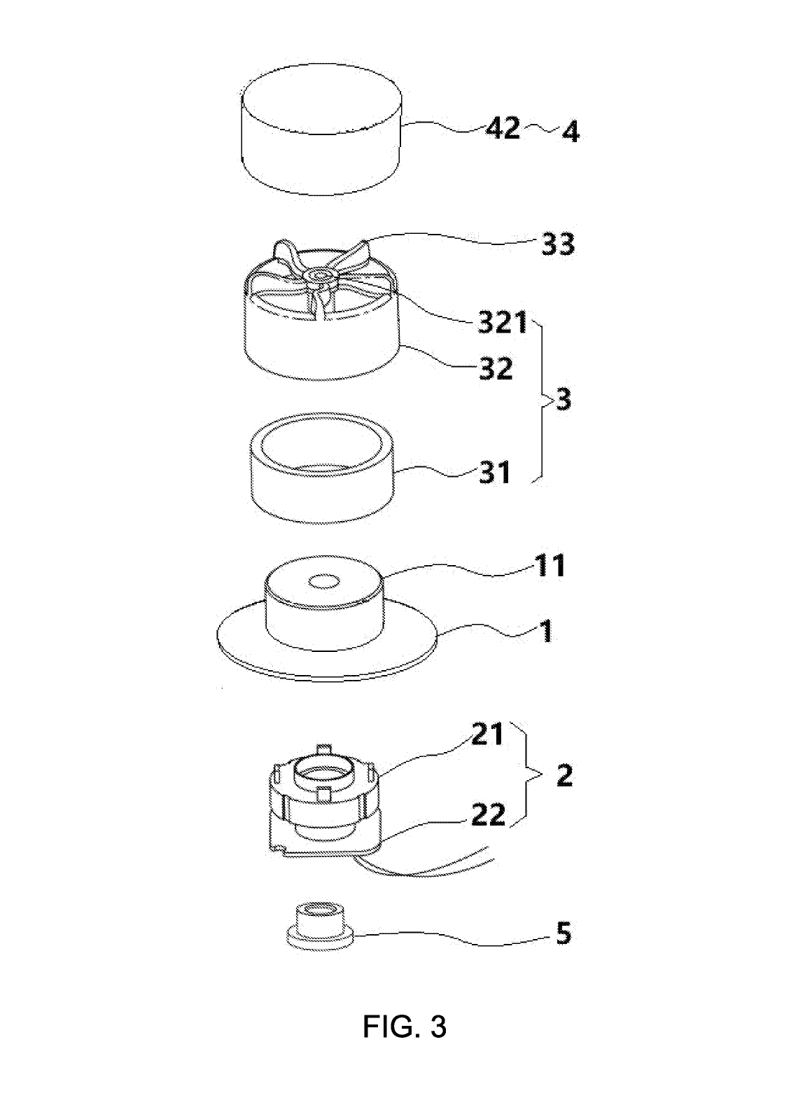

In an implementation mode, as shown in FIG. 3, the rotor fixing member 4 is the rotating shaft 41 or the limiting element 42. In this embodiment, the rotor fixing member is the limiting component. Providing the limit element can effectively prevent damage to the rotating magnet and limit it to prevent it from detaching from the cylindrical convex shell. Of course, the above structural design is not limited to this and can be other structures that serve the same purpose.

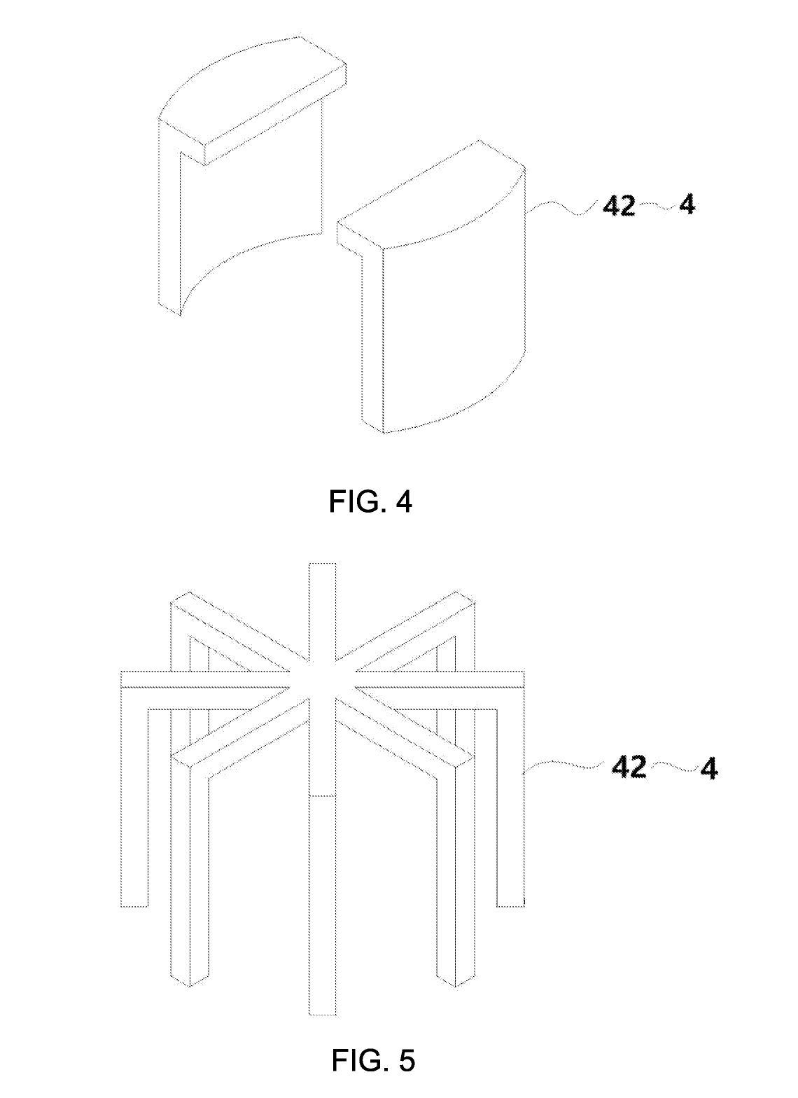

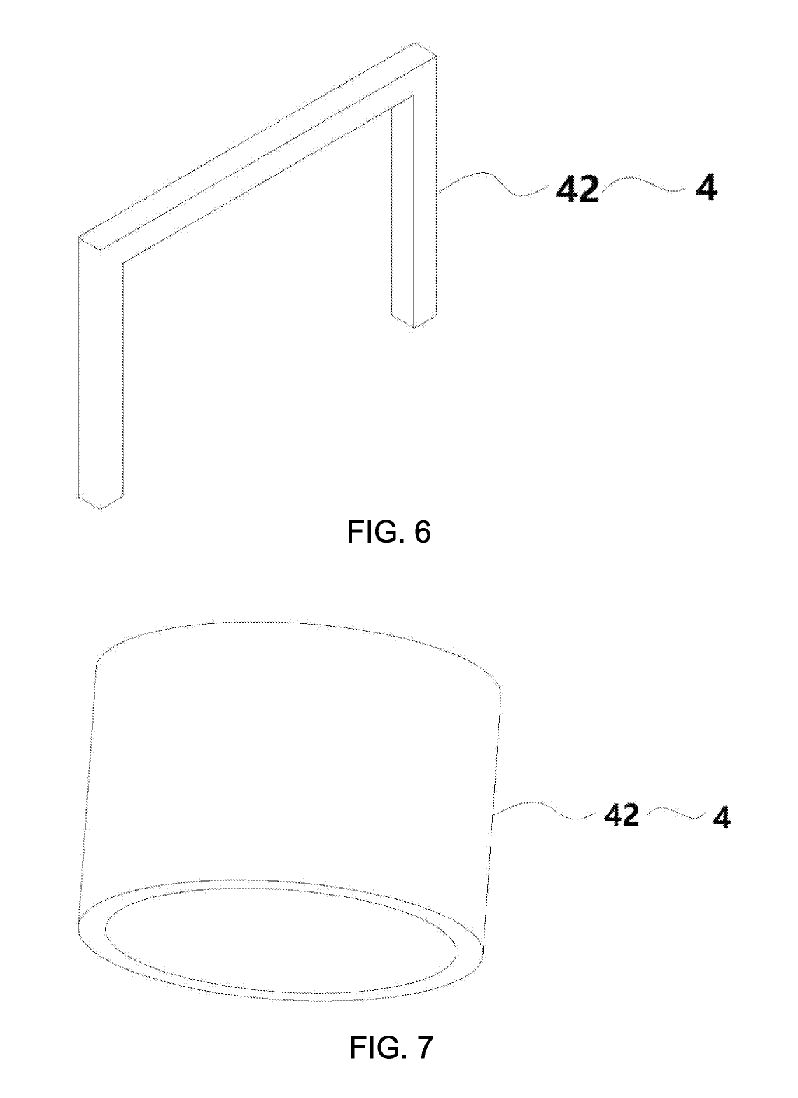

In an implementation mode, as shown in FIGS. 4-7, the limiting element 42 is a "7" - shaped frame, a cross shaped frame, a meter shaped frame, a "il" character shaped frame, or a shell that matches the rotor component 3. In this embodiment, the limiting element 42 is the "7"- shaped frame. Of course, the limiting element is not limited to this and can be other shapes or structures that serve the same purpose.

Working principle: the brushless motor structure includes a housing, a stator component, and a rotor component. The housing is matched with the stator component and the rotor component. The rotor component is provided on the housing, and the stator component is externally provided below the housing. The stator component is fixedly connected to the housing. After the stator component is powered on, the rotor component is rotated relative to the housing through the stator component. The housing is provided with a cylindrical convex shell, which is fixedly connected or integrally formed with the housing. The rotor component is sleeved on the cylindrical convex shell, and the stator component is provided below the cylindrical convex shell. The stator component is fixedly connected to the cylindrical convex shell and/or the housing. After the stator component is powered on, the rotor component is rotated relative to the cylindrical convex shell through the stator component. Through this structural design, the stator and rotor components are separated and placed above and below the cylindrical convex shell. On the one hand, when the brushless motor structure is applied in the field of craft water drawing, the stator will not be damaged due to water leakage. On the other hand, when the stator component is damaged, only the stator component needs to be replaced, without replacing the entire motor, thereby effectively reducing maintenance costs. A rotor fixing member is provided on the rotor component and/or housing to prevent the rotor component from disengaging from rotation, and the rotor fixing member is fixedly connected or integrally with the housing and/or the cylindrical convex shell. Through this design, the rotor component can be effectively prevented from detaching. When the rotor component is placed in liquid, it will not detach from the cylindrical convex shell due to the buoyancy of the liquid.

The various technical features of the above embodiments can be combined in any way. In order to make the description concise, not all possible combinations of the various technical features in the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the present disclosure. It should be noted that for those skilled in the art, several modifications and improvements can be made without departing from the inventive concept, which are within the protection scope of the present disclosure. Therefore, the protection scope of the present disclosure should be based on the appended claims.

What is claimed is:

1. A brushless motor structure, comprising a housing, a stator component, and a rotor component,
wherein the housing is matched with the stator component and the rotor component,
the rotor component is provided on the housing, the stator component is provided below the housing,
the stator component and the housing are fixedly connected, and the rotor component is rotated relative to the housing through the stator component.

2. The brushless motor structure according to claim 1, wherein a cylindrical convex shell is provided on the housing, the cylindrical convex shell is fixedly connected or integrally formed with the housing,
the rotor component is sleeved on the cylindrical convex shell, the stator component is provided below the cylindrical convex shell,
the stator component is fixedly connected to the cylindrical convex shell and/or the housing, and the rotor component is rotated relative to the cylindrical convex shell through the stator component.

3. The brushless motor structure according to claim 2, wherein a rotor fixing member configured to prevent the rotor component from disengaging from rotation is provided on the
rotor component and/or the housing,the rotor fixing member is fixedly connected or integrally formed with the housing and/or the cylindrical convex shell.

4. The brushless motor structure according to claim 3, wherein the rotor fixing member is a rotating shaft or a limiting element.

5. The brushless motor structure according to claim 4, wherein a limit block configured to prevent the rotor component from detaching during rotation is provided on the rotating shaft,
the rotor component is matched and connected to the rotating shaft, and the rotor component is rotated relative to the rotating shaft through the stator component.

6. The brushless motor structure according to claim 5, wherein a shaft hole matching with the rotating shaft is provided on the rotor component, and a width of the limit block is greater than a diameter of the shaft hole.

7. The brushless motor structure according to claim 4, wherein the limiting element is a
"7"- shaped frame, a cross shaped frame, a M-shaped frame, a "il" character shaped frame, or a shell matched with the rotor component.

8. The brushless motor structure according to claim 7, wherein the rotor component comprises a rotating magnet and a magnet shell that are matched with each other,
the rotating magnet and the magnet shell are fixedly connected,
the rotating magnet and the magnet shell are integrally sleeved on the cylindrical convex shell.

9. The brushless motor structure according to claim 8, wherein a power link is provided on the magnet shell, and the power link is fixedly connected or integrally formed with the magnet shell;
the power link is rotated through a rotation of the rotating magnet and the magnet shell.

10. The brushless motor structure according to claim 9, wherein the power link is an impeller, a connection groove, or a connection buckle.

11. The brushless motor structure according to claim 10, wherein the rotating magnet is a magnetic ring or a magnetic sheet.

12. The brushless motor structure according to claim 11, wherein the stator component comprises a stator and a control board,
the stator and the control board are connected, and the control board is connected to an external power source.

13. The brushless motor structure according to claim 12, wherein a bottom of the housing
is provided with a stator fixing part, and the stator component is fixedly connected to the housing or the cylindrical convex shell through the stator fixing part.

14. The brushless motor structure according to claim 13, wherein the stator fixing part is fixedly connected to the housing or the cylindrical convex shell in a sealing manner.
